(19) United States
(12) Patent Application Publication
(10) Pub. No.: US 2005/0017049 A1
(43) Pub. Date: Jan. 27, 2005

(54) Nail gun tip adapter

(76) Inventor: Brian C. Betz, Sunbury, PA (US)

Correspondence Address: Kenneth P. Glynn, Esq.;Glynn & Associates, P.C., 24 Mine Street, Flemington, NJ, 08822, US

(21) Appl. No.: 10/627,835

(22) Filed: Jul. 25, 2003

(51) Int. Cl. B25C 5/02

(52) U.S. Cl. 227/119

(57) ABSTRACT

The present invention is an adapter for the firing tip of a nail gun to enhance utility and accuracy. The adapter is a member having a top, a bottom, and sidewalls. The member has an upper hollow portion having a cylindrical shape, a predetermined depth and a predetermined diameter, and has a lower hollow portion having at least one cross section that is less than the predetermined diameter of the upper hollow portion. The upper hollow portion and the lower hollow portion are connected and establish a complete passage through the member from the top to the bottom. The member has an outer lower portion that includes at least one taper that is tapered inwardly toward the bottom. Alternatively, the member has an inner lower portion that includes at least two internal tapers that taper outwardly toward the bottom. The sidewalls may be a single continuous sidewall, especially a circular sidewall of a predetermined diameter. In preferred embodiments, the outer lower portion is tapered with two tapers, one opposite the other. These may be two tapers that are flat planer tapers. The flat planer tapers may form an angle of about 20° to 45° with the bottom, e.g. about 30° is beneficial. In other preferred embodiments, at least one of the two tapers may be a curved taper. For example, the curved taper may be concave to fit to a groove ledge, e.g. wherein the curved taper has a fixed diameter.

### BACKGROUND OF THE INVENTION

1. Field of the Invention

The present invention relates to nail guns, and, more particularly, to devices for utilizing nail guns with tongue and groove boards, more effectively. The present invention device is a nail gun adapter that has at least one tapered side to make it easier to fit a nail gun into a tongue or a groove and accurately and successfully fire a nail where it is desired at the angle desired. The present invention device enables a nail gun user to shoot the nail quicker, with great accuracy in a sliding motion rather than in the traditional pull up and put down method.

2. Information Disclosure Statement

The following patents are representative of nail gun prior art:

U.S. Pat. No. 3,982,313 describes an automatic fastening system and method that is disclosed for use in fastening deck boards to stringers in a pellet-making machine or the like. The automatic fastening system of the preferred embodiment comprises an adjustable frame having a plurality of staple guns pivotably mounted on the frame and has automatic positioning means, in the form of a wheel, associated with each staple gun for positioning the staple guns by automatically raising and lowering the staple guns as the height of the pallet deck board changes and as the height of the pallet structure changes depending upon whether or not stringer-type pallets or block-type pallets are being manufactured. Also disclosed is an automatic firing pneumatic circuit for the subject fastening system and a method for automatically fastening a plurality of deck boards to a plurality of stringers.

U.S. Pat. No. 5,649,660 describes a sharpshooting nail gun capable of driving a nail into an intended spot. The nail gun includes a bit guide having an injection groove through which a nail and a drive bit pass. A contact arm is movably supported to the bit guide. The contact arm has a lower tapered end portion abuttable against a wall or attachment member, and an upper portion engageable with a trigger. When the contact arm is biased toward the wall, the upper portion is disengaged from the trigger to be manipulatable. The lower portion of the contact arm protrudes from a lower end of the bit guide, and is provided with an injection bore extending in alignment with the injection groove.

U.S. Pat. No. 6,279,808 describes a nail guide mechanism, suitable for use with a wide variety of nail guns, having a mounting bracket to permit ready attachment and/or removal in the field. The guide mechanism, when mounted, is oriented about the channel defined by the nose of the nail gun. The guide mechanism includes a partially pre-compressed spring that includes a bias on a pivoting arm such that the arm is caused to protrude at least partially into the channel. The arm is thus positioned to continuously exert a force on the nails as they are driven down the channel past the arm. Because the spring is only partially pre-compressed, the positioning of the arm is responsive to changes in conditions inside the channel, such as when the head of a nail passed by the arm. The force exerted by the arm, under the influence of the spring, acts substantially along the radial axis of the nail, and is exerted on the nail during at least a portion of the time that the nail is being impelled by the driving mechanism of the nail gun. The result of the force thus exerted is that every nail is pushed to a desired position in the channel, thereby ensuring consistent orientation of the nails as they exit the nail gun. The guide mechanism also includes a pilot which, when the mechanism is mounted, is located immediately adjacent to the channel. The pilot has a small tip that is inserted into the nail hole so as to provide assurance that the nail gun is properly located. The pilot thereby cooperates with the arm to ensure accurate and consistent placement and orientation of each nail as it exits the gun.

U.S. Pat. No. 6,318,617 describes a box nailing machine. In the box nailing machine, a seat has an inner space. A base is installed below the seat. A nail stopper is installed above the base in the inner space of the seat and being confined by the inner space to move up and down. A nail receiving space is positioned between the nail stopper and the base in the seat; and an adjustable stud is passed through the seat and nail stopper. Thereby as the adjustable stud is rotated, the nail stopper is driven to be moved up and down for changing a volume of the nail receiving space.

U.S. Pat. No. 6,578,749 describes a nail device for a power nailer that includes a nose portion of the power nailer by a pin passing through a orifice of the guiding member and a pivot hole of the connecting portion. The passage of the leading edge contacts against the inside of the semi-circle passage by the virtue of a first end of a spring engaging to a protrusion of the connecting portion and a second end of spring engaging to a bulge of the guiding member.

Notwithstanding the prior art, the present invention is neither taught nor rendered obvious thereby.

### SUMMARY OF THE INVENTION

The present invention is an adapter for the firing tip of a nail gun to enhance utility and accuracy. The adapter is a member having a top, a bottom, and sidewalls. The member has an upper hollow portion having a cylindrical shape, a predetermined depth and a predetermined diameter, and has a lower hollow portion having at least one cross section that is less than the predetermined diameter of the upper hollow portion. The upper hollow portion and the lower hollow portion are connected and establish a complete passage through the member from the top to the bottom. The member has an outer lower portion that includes at least one taper that is tapered inwardly toward the bottom. Alternatively, the member has an inner lower portion that includes at least two internal tapers that taper outwardly toward the bottom. The sidewalls may be a single continuous sidewall, especially a circular sidewall of a predetermined diameter. In preferred embodiments, the outer lower portion is tapered with two tapers, one opposite the other. These may be two tapers that are flat planer tapers. The flat planer tapers may form an angle of about 20° to 45° with the bottom, e.g. about 30° is beneficial. In other preferred embodiments, at least one of the two tapers may be a curved taper. For example, the curved taper may be concave to fit to a groove ledge, e.g. wherein the curved taper has a fixed diameter.

The present invention adapter member may be made of any functional wood, composite, aluminum, nylon, e.g. PET, but is preferably material selected from the group consisting of metal, plastic and rubber.

The present invention also includes the combination of a nail gun and the aforesaid adapter.

### BRIEF DESCRIPTION OF THE DRAWINGS

The present invention should be more fully understood when the specification herein is taken in conjunction with the drawings appended hereto wherein:

FIGS. 1, 2 and 3 show a side view, side cut view and top view respectively of one embodiment of the present invention nail gun adapter;

FIG. 4 shows a side view of another alternative embodiment present invention nail gun tip adapter device;

FIG. 5 shows a top view of a third embodiment of an oval shaped present invention nail gun tip adapter device;

FIGS. 6 and 7 show side views of two more embodiments of the present invention device;

FIG. 8 shows another present invention embodiment wherein the adapter tapers are internal;

FIG. 9 shows a top view of another preferred embodiment of the present invention device;

FIG. 10 shows a side view of a present invention combination nail gun and adapter; and,

FIGS. 11 and 12 show perspective views of one embodiment of the present invention being used with man-made composite tongue and grove deckboards

### DETAILED DESCRIPTION OF THE PRESENT INVENTION

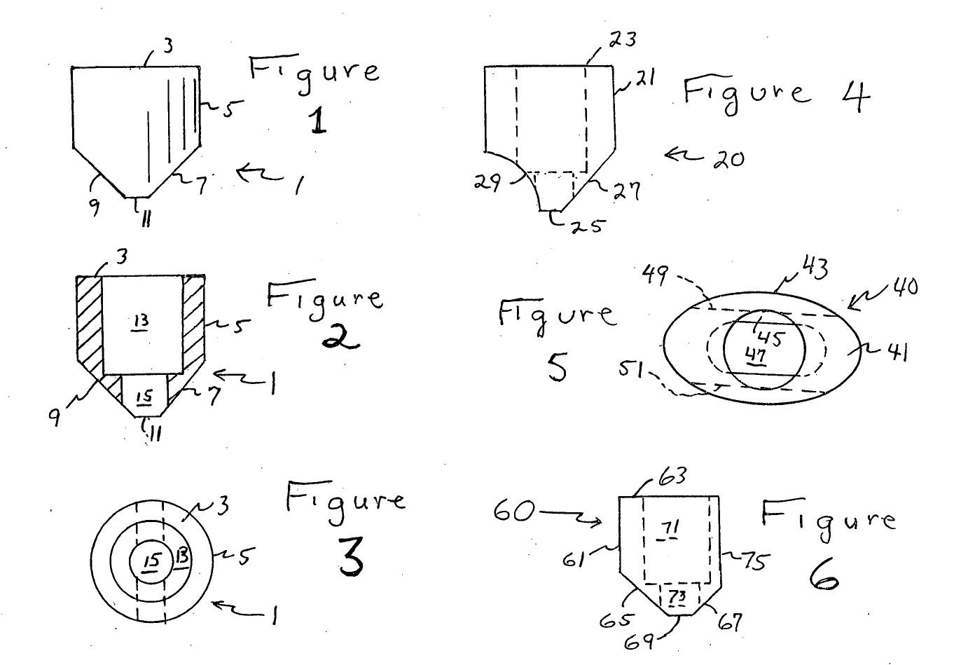

Referring collectively to FIGS. 1, 2 and 3, there is shown a present invention nail gun adapter 1 for attachment to cylindrical or partially cylindrical nail gun firing tips to enable nail guns to be positioned in non-slipping position to shoot individual nails into tongue and groove boards at the tongues and at the grooves. Adapter 1 is generally cylindrical, having a round outer wall 5, a top 3 and a bottom 11. Two flat planer tapers 7 and 9 have been cut at approximately 30° from the bottom 1 1. A hollow upper portion 13, a cylinder, connects to a hollow lower portion 15. A hollow upper portion 13 has a predetermined depth and diameter so as to very tightly fit onto a nail gun firing tip. Lower hollow portion 15 has a cross section, at least in one area that is less than the predetermined diameter of the upper hollow portion 13. This creates a passage through adapter 1 for a nail to fired through. In actual use, the bottom 11 becomes the adapter firing tip and is placed where the nail is desired and positioned so that either taper 7 or taper 9 or both touches a tongue or groove surface to stabilize the gun for accurate firing.

In this case, lower hollow portion 15 is cylindrical, but could be of any configuration that would function as a stop when the adapter is slid onto a nail gun firing tip, and would also enable a nail to pass through it. Also, it is contemplated that any choice of material of construction that would function as a guide could be used. These materials could be machined, molded, cast, or otherwise formed.

FIG. 4 shows another preferred embodiment present invention nail gun adapter 20. It is also formed from a cylindrical member with an internal configuration that is essentially the same as that shown in FIG. 2. Adapter 20 has a sidewall 21, a flat taper 27 and a bottom 25. Opposite flat taper 27, in this case, is a concave curved taper 29. Thus, adapter 20 may be utilized with taper 27 as a guide or curved taper 29 as a guide against a surface of a groove.

FIG. 5 shows a top view of an oval adapter 40. It has a top 41, sidewalls 43, a hollow portion 47 and an elliptical lower portion 45 having a narrow cross section to create a stop. The cylindrical oval has tapered sections 49 and 51 that taper inwardly to its bottom.

FIG. 6 shows another present invention nail gun adapter 60. It is formed from a cylindrical member with sidewalls 61 and top 63 and bottom 69. It has a wide cylindrical upper portion 71 and a narrower hollow portion 73 and tapers 65 and 67. Adapter 60 of this figure is similar to adapter 1 of FIG. 1, except that a flat wall 71 has been created to provide an additional guiding surface. This would be especially beneficial for grooves of composite boards wherein the groove spacing will benefit from the particular cuts of the adapter.

FIG. 7 shows present invention adapter 80 that incorporate the features of adapter 20 of FIG. 4 and adapter 60 in FIG. 6. Thus, adapter 80 includes two flat tapers 87 and 89 and a concave upper cut 91. It has an internal configuration identical to that shown in FIG. 2 and has sidewalls 81, top 83 and bottom 85. Utilizing this adapter 80 on a conventional nail gun allows a user to rely upon two flat tapers 87 and 89 or a concave upper cut 91 or combination on any two of these for bracing the nail gun, for accurate positioning and angling.

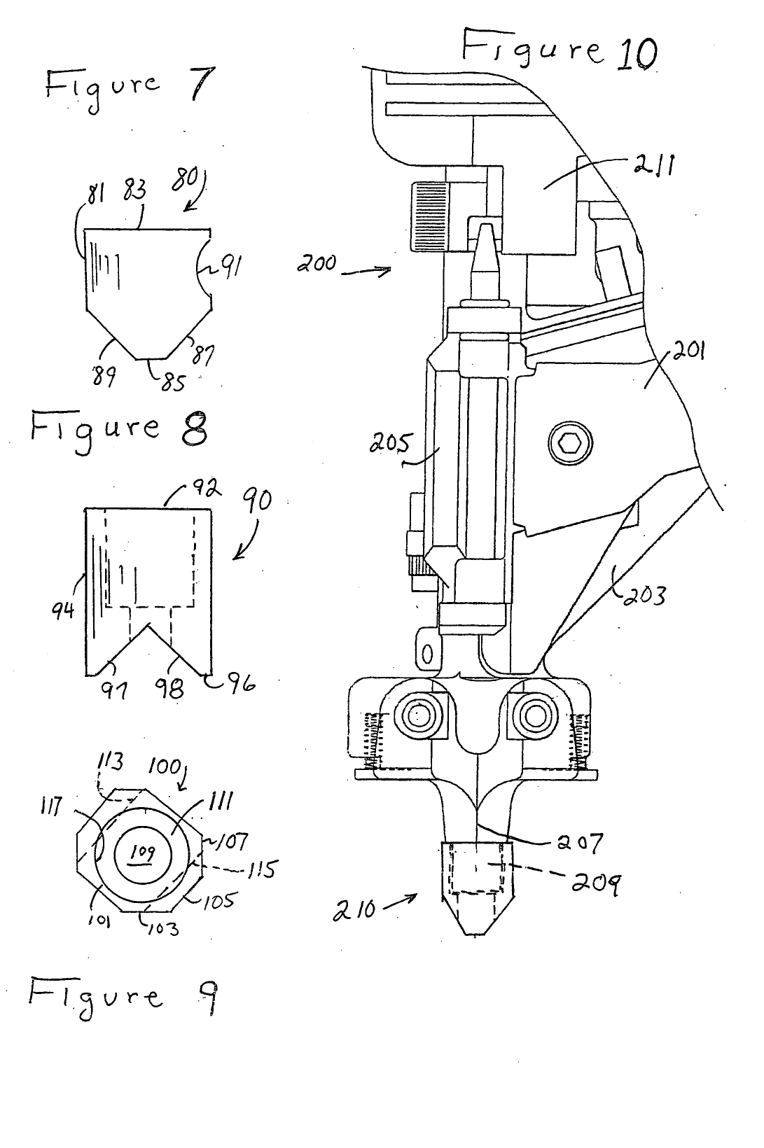

FIG. 8 illustrates another alternative embodiment of the present invention. However, this embodiment is the reverse of that shown in FIG. 1 because instead of having an outer lower portion with tapers that taper inwardly toward the bottom, this embodiment involves an inner lower portion that tapers outwardly toward the bottom. It fits over a groove ledge or over a tongue instead of in a groove or on a tongue ledge.

FIG. 8 shows adapter 90 with top 92, cylindrical sidewall 94, bottom 96 and inner lower portion tapers 97 and 98. These taper outwardly toward bottom 96, as shown.

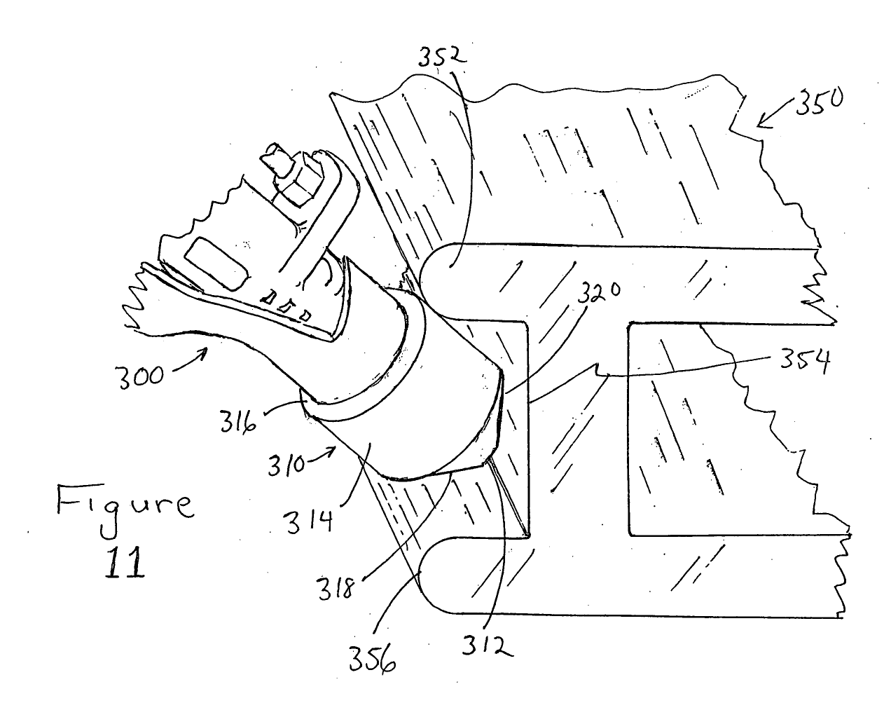

FIG. 9 shows a top view of another adapter 100 that has an asymmetric, non-cylindrical configuration with irregular sidewall facets. Although this is an unlikely version of the present invention, it provides another illustration of the scope of the present invention. Adapter 100 includes a top 101, eight sidewall facets, such as facets 103, 105 and 107. There is a cylindrical hollow upper portion and a smaller hollow lower portion 109, and tapers 113 and 115.

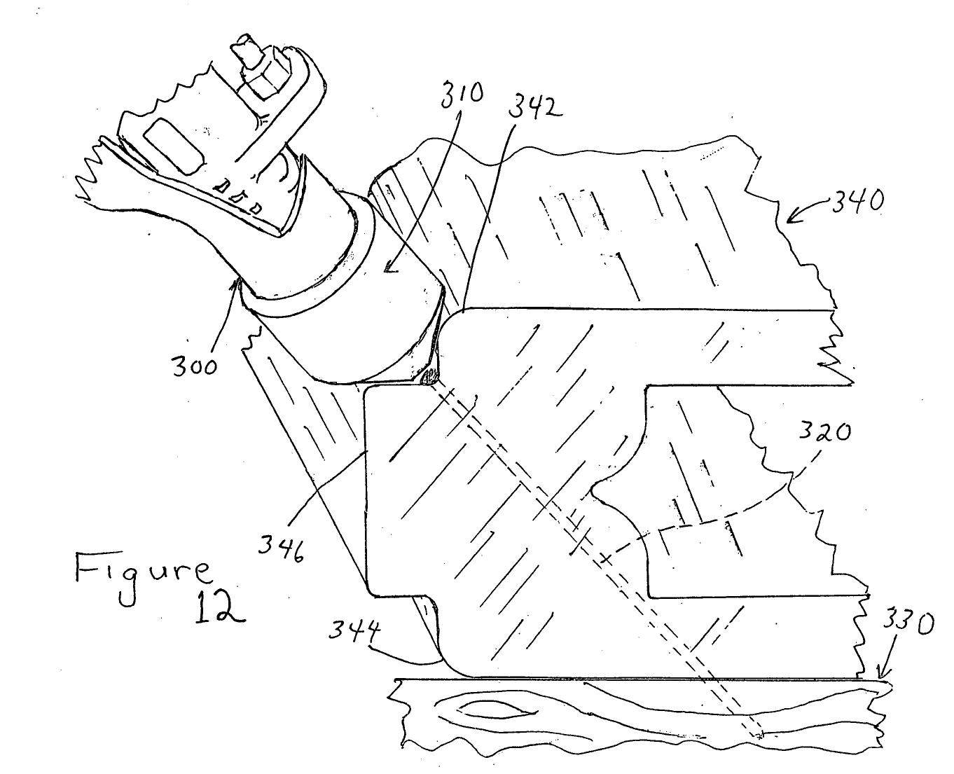

FIG. 10 shows a side view of a present invention combination nail gun and adapter. Nail gun 200 is a conventional nail gun with standard features, including a handle 201 (partially shown), a nail gun feeder 203, a firing barrel 205, a power source 211, a head 207 and a firing top 209. Adapter 210, similar to adapter 1 of FIG. 1, is very tightly fit onto firing top 209 to act as a guide, as described above and below. By using adapter 210 or another adapter of the present invention, all of the problems that arose with conventional nail guns on tongue and groove boards are reduced or eliminated. For example, by using one taper or the other, or both, the nail gun will be positioned for depth and angle and the likelihood of incorrect angle or depth shots is eliminated. Also, without the present invention adapter it is impossible to maintain a nail gun in the same position and slide it along a tongue or groove. However, using a present invention adapter, the gun will smoothly slide along the tongue or groove, and replicating shots are achieved rapidly and accurately.

FIG. 11 shows, combination present invention nail gun 300 and adapter 310 in a large groove or a synthetic board 350. Board 350 has a top plate 352 extending outwardly as shown and a bottom plate 356 extending outwardly as shown, creating a large groove 354.

In FIG. 11, adapter 310 has a top 316, a sidewall 314, a bottom 312 and tapers 318 and 320. A user rests bottom 312 at the intersection of bottom plate 356, and a large groove 354 so as to fix the depth and angle of a nail to be fired and to enable the user to maintain the position while sliding along and firing as needed.

FIG. 12 shows the same nail gun 300 and adapter 310, but this time operating along the top ledge of the tongue. Thus, board 340 had a tongue 346 with indicated top 342 and bottom 344, as shown. Here, nail 320 has already been fired and is attaching board 340 to wooden joist 330, to create decking.

Obviously, numerous modifications and variations of the present invention are possible in light of the above teachings. It is therefore understood that within the scope of the appended claims, the invention may be practiced otherwise than as specifically described herein.

1. An adapter for the firing tip of a nail gun, which comprises:
a member having a top, a bottom, and sidewalls, said member having an upper hollow portion having a cylindrical shape, a predetermined depth and a predetermined diameter, and having a lower hollow portion having at least one cross section that is less than said predetermined diameter, said upper hollow portion and said lower hollow portion being connected and establishing a complete passage through said member from said top to said bottom, said member having an inner lower portion that includes at least two internal tapers that are tapered outwardly toward said bottom.

2. The adapter of claim 1 wherein said member sidewalls is a circular sidewall of a predetermined diameter.

3. The adapter of claim 1 wherein said outer lower portion is tapered with two tapers, one opposite the other.

4. The adapter of claim 3 wherein each of said two tapers are flat planer tapers.

5. The adapter of claim 4 wherein said flat planer tapers to form an angle of about 20° to 45° with said bottom.

6. The adapter of claim 3 wherein said at least one of said two tapers is a curved taper.

7. The adapter of claim 6 wherein said curved taper is concave.

8. The adapter of claim 7 wherein said curved taper has a fixed diameter.

9. The adapter of claim 1 wherein said member is made of a material selected from the group consisting of metal, plastic and rubber.

10. The adapter of claim 1 wherein said lower hollow portion has a cylindrical shape and has a diameter that is less than said predetermined diameter of said upper hollow portion.

11. An adapter for the firing tip of a nail gun, which comprises:
a member having a top, a bottom, and sidewalls, said member having an upper hollow portion having a cylindrical shape, a predetermined depth and a predetermined diameter, and having a lower hollow portion having at least one cross section that is less than said predetermined diameter, said upper hollow portion and said lower hollow portion being connected and establishing a complete passage through said member from said top to said bottom, said member having an inner lower portion that includes at least two internal tapers that are tapered outwardly toward said bottom.

12. A nail gun and adapter, which comprises:
a.) a nail gun having a power source for feeding and firing nails, a nail feeder, and a firing tip for exit of fired nails, said firing tip having a cylindrical outer shape with a fixed tip diameter; and,
b.) an adapter, being a member having a top, a bottom, and sidewalls, said member having an upper hollow portion having a cylindrical shape, a predetermined depth and a predetermined diameter, and having a lower hollow portion having at least one cross section that is less than said predetermined diameter, said upper hollow portion and said lower hollow portion being connected and establishing a complete passage through said member from said top to said bottom, said member having an outer lower portion that includes at least one tape that is tapered inwardly toward said bottom wherein said predetermined diameter of said upper hollow portion of said member is appropriately equal to said fixed tip diameter, and wherein said upper hollow portion of said member is tightly fitted to said firing tip.

13. The nail gun and adapter of claim 12 wherein said member sidewalls is a circular sidewall of a predetermined diameter.

14. The nail gun and adapter of claim 12 wherein said outer lower portion is tapered with two tapers, one opposite the other.

15. The nail gun and adapter of claim 14 each of said two tapers are flat planer tapers.

16. The nail gun and adapter of claim 14 wherein said at least one of said two tapers is a curved taper.

17. The nail gun and adapter of claim 16 wherein said curved taper is concave.

18. The nail gun and adapter of claim 16 wherein said curved taper has a is fixed diameter.

19. The nail gun and adapter of claim 12 wherein said member is made of a material selected from the group consisting of metal, plastic and rubber.

20. The nail gun and adapter of claim 12 wherein said lower hollow portion has a cylindrical shape and has a diameter that is less than said predetermined diameter of said upper hollow portion.
